(19) United States
(12) Patent Application Publication
(10) Pub. No.: US 2023/0206903 A1
(43) Pub. Date: Jun. 29, 2023

(54) METHOD AND APPARATUS FOR IDENTIFYING AN EPISODE IN A MULTI-PARTY MULTIMEDIA COMMUNICATION

(71) Applicant: Uniphore Technologies, Inc., Palo Alto, CA (US)

(72) Inventors: Saurabh Saxena, San Jose, CA (US); James Gibson, Los Angeles, CA (US); Mercedes Garcia, Valencia (ES); Maria Pocovi, Valencia (ES)

(21) Appl. No.: 18/116,294

(22) Filed: Mar. 1, 2023

Related U.S. Application Data
(63) Continuation-in-part of application No. PCT/US22/53909, filed on Dec. 23, 2022.
(60) Provisional application No. 63/293,659, filed on Dec. 23, 2021.

(51) Int. Cl. G10L 15/02; G06F 40/279; H04L 12/18

(52) U.S. Cl. CPC G10L 15/02; G06F 40/279; H04L 12/1831; G10L 15/26

(57) ABSTRACT

An apparatus for identifying an episode in a multi-party multimedia communication includes a processor, and a memory storing instructions that, when executed by the processor, configure the apparatus to perform a method. The method includes receiving multi-modal data including video data and audio data for each of multiple participants. Vision information and at least one of tonal information or text information is used to determine a representative participation score (RPS) for one or more participants. An episode is identified during or proximate to pronounced RPS movement, and sent for display.

### CROSS-REFERENCE TO RELATED APPLICATIONS

This application claims priority to the International Patent Application No. PCT/US2022/053909 filed on 23 Dec. 2022, which claims priority to the U.S. Provisional Patent Application Serial No. 63/293,659, filed on 23 Dec. 2021, each of which is incorporated by reference herein.

### FIELD

The present invention relates generally to video and audio processing, and specifically to identify an episode in a multi-party multimedia communication.

### BACKGROUND

Several business and non-business meetings are now conducted in a multimedia mode, for example, web-based audio and video conferences including multiple participants. Reviewing such multimedia meetings, in which significant amount of data, different modes of data is shared and presented, to identify key information therefrom has proven to be cumbersome and impractical. While there exists a wealth of information regarding various participants in such meetings, it has been difficult to extract meaningful information from such meetings.

Accordingly, there exists a need in the art for techniques for identifying an episode in a multi-party multimedia communication.

### SUMMARY

The present invention provides a method and an apparatus for identifying an episode in a multi-party multimedia communication, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an apparatus for identifying an episode in a multi-party multimedia communication, according to one or more embodiments.

FIG. 2 illustrates the analytics server of FIG. 1, according to one or more embodiments.

FIG. 3 illustrates the user device of FIG. 1, according to one or more embodiments.

FIG. 4 illustrates a method for determining a representative participant score (RPS) in a multi-party multimedia communication, for example, as performed by the apparatus of FIG. 1, according to one or more embodiments.

FIG. 5 illustrates a method for identifying key moments in a multi-party multimedia communication, for example, as performed by the apparatus of FIG. 1, according to one or more embodiments.

FIG. 6 illustrates a method for generating hyper-relevant text keyphrases, according to one or more embodiments.

FIG. 7 illustrates an aspect of the subject matter in accordance with one embodiment.

### DETAILED DESCRIPTION

Embodiments of the present invention relate to a method and an apparatus for identifying an episode in a multimedia communication, for example, a video conference call or between multiple participants. Participation is broadly assessed by assessing the engagement, and the sentiment (for example, derived based on tonal data or text data) of the participants, for example, during the call, after the call, and as a group including some or all participants. The conference call video is processed to extract visual or vision data, for example, facial expression analysis data, and the audio is processed to extract tonal data and optionally text data, for example, text transcribed from the speech of the participants. The multiple modes of data from the meeting, viz., vision data, tonal data and optionally text data (multi-modal data) is used, for example, by trained artificial intelligence and/or machine learning (AI/ML) models or algorithmic models, to assess several parameters for each participant. The assessment based on multiple modes of data is then fused or combined on a time scale to generate fused data or a representative participation score (RPS), which includes a score for engagement and a score for sentiment of each participant.

The RPS scores are aggregated for each participant for the entire meeting, and for all participants for the entire meeting. In some embodiments, the RPS is computed in real time for each participant based on vison and tonal data for immediate recent data, while in some embodiments, the RPS is computed based on vision, tonal and text data for immediate recent data. In some embodiments, the RPS is computed for each participant based on vision, tonal and text data for the entire meeting. Variations or swings in RPS score of one or more participants is used to identify important phases (time periods) of the meeting. In some embodiments, conversations during such important phases or proximate to such important phases, related to a common topic are identified as episodes. Episodes during or proximate to such phases are considered to be associated with the pronounced RPS movement.

In some embodiments, a list of highly relevant terms is used in conjunction with text data to identify impact on sentiment or engagement of the participants for a particular meeting, or over several meetings with same or different participants. The highly relevant terms found in the episodes is identified as being relevant to the pronounced RPS.

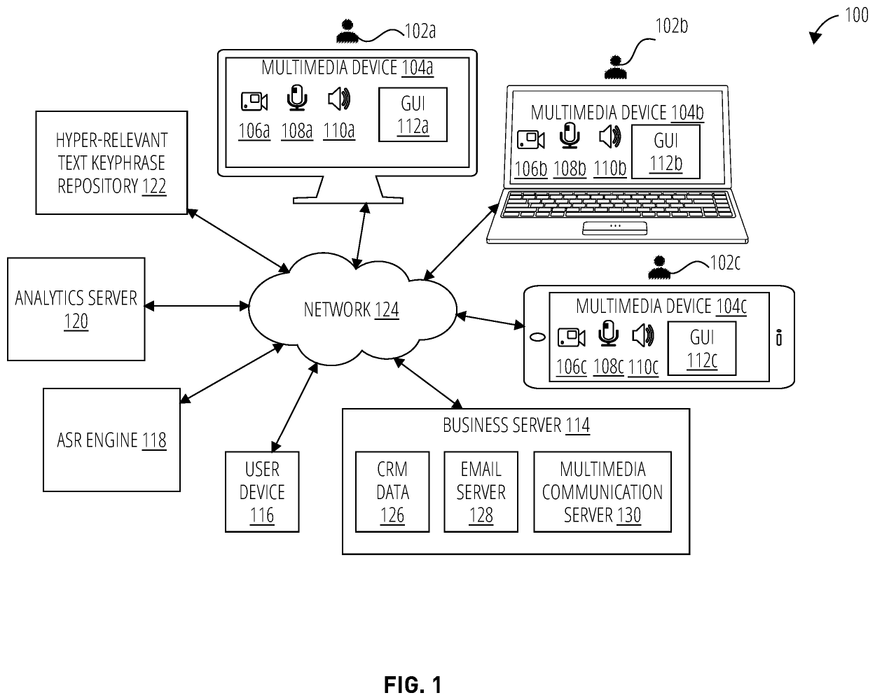

FIG. 1 is a schematic representation of an apparatus 100 for identifying key information in a multimedia communication, according to one or more embodiments of the invention. FIG. 1 shows a participant 102a of a business in a discussion to the business' customers, for example, the participant 102b and 102c (together referred to by the numeral 102). The apparatus 100 includes all components shown in FIG. 1, and do not include the participants themselves. Each participant 102 is associated with a multimedia device 104a, 104b, 104c (together referred to by the numeral 104) via which each participant communicates with others in the multi-party communication or a meeting. For example, such meetings are enabled by ZOOM VIDEO COMMUNICATIONS, INC. of San Jose, Calif., MICROSOFT CORPORATION of Redmond, Wash., WEBEX by CISCO Systems of Milpitas, Calif., among several other similar web-based or other multimedia/videoconferencing providers. Each of the multimedia device 104a, 104b, 104c is a computing device, such as a laptop, personal computer, tablet, smartphone or a similar device that includes or is operably coupled to, respectively, a camera 106a, 106b, 106c, a microphone 108a, 108b, 108c, a speaker 110a, 110b, 110c, and a graphical user interface (GUI) 112a, 112b, 112c, for example, to display the ongoing meeting, or a concluded meeting, and analytics thereon. In some embodiments, two or more participants 102 may share a multimedia device to participate in the meeting. In such embodiments, the video of the meeting is used for generating the facial expression analysis data, and the audio of the meeting is used to generate tonal and/or text data for all the participants sharing the multimedia device, for example, using techniques known in the art. The apparatus 100 also includes a business server 114, a user device 116, an automatic speech recognition (ASR) engine 118, an analytics server 120 and a hyper-relevant text keyphrase (HRTK) repository 122. Various elements of the apparatus 100 are capable of being communicably coupled via a network 124 or via other communication links as known in the art, and are coupled as and when needed.

The business server 114 provides services such as customer relationship management (CRM), email, multimedia meetings, for example, audio and video meetings to the participants 102, for example, employees of the business and of the business' customer(s). In some embodiments, the business server 114 is configured to use one or more third party services. The business server 114 is configured to extract data, for example, from any of the services it provides, and provide it to other elements of the apparatus 100, for example, the user device 116, the ASR engine or the analytics server 120. For example, the business server 114 may send audio and or video data captured by the multimedia devices 104 to the elements of the apparatus 100.

The user device 116 is an optional device, usable by persons other than the participants 102 to view the meeting with the assessment of the participation generated by the apparatus 100. In some embodiments, the user device 116 is similar to the multimedia devices 104.

The ASR engine 118 is configured to convert speech from the audio of the meeting to text, and can be a commercially available engine or proprietary ASR engines. In some embodiments, the ASR engine 118 is implemented on the analytics server 120.

The analytics server 120 is configured to receive the multi-modal data from the meeting, for example, from the multimedia devices 104 directly or via the business server 114, and process the multi-modal data to determine or assess participation in a meeting.

The HRTK repository 122 is a database of key phrases identified or predefined as relevant to an industry, domain or customers.

The network 124 is a communication Network, such as any of the several communication Networks known in the art, and for example a packet data switching Network such as the Internet, a proprietary Network, a wireless GSM Network, among others.

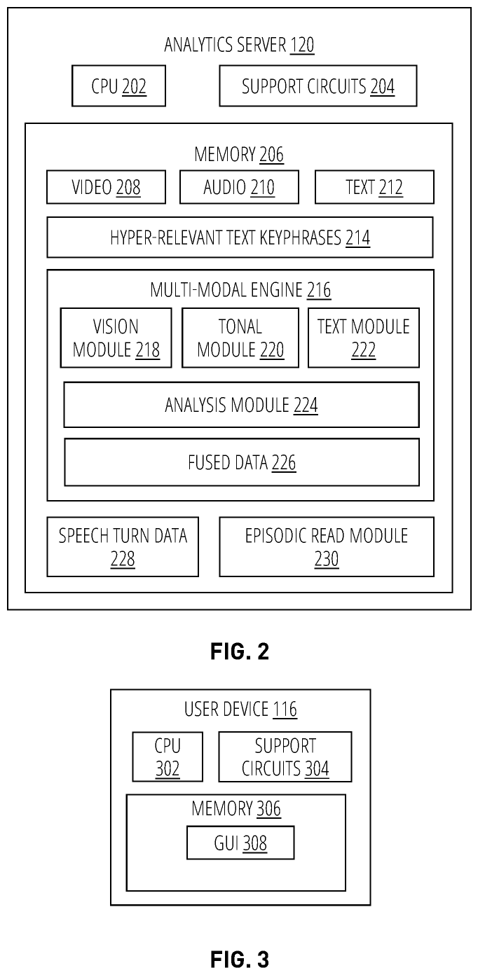

FIG. 2 is a schematic representation of the analytics server 120 of FIG. 1, according to one or more embodiments. The analytics server 120 includes a CPU 202 communicatively coupled to support circuits 204 and a memory 206. The CPU 202 may be any commercially available processor, microprocessor, microcontroller, and the like. The support circuits 204 comprise well-known circuits that provide functionality to the CPU 202, such as, a user interface, clock circuits, network communications, cache, power supplies, I/O circuits, and the like. The memory 206 is any form of digital storage used for storing data and executable software. Such memory includes, but is not limited to, random access memory, read only memory, disk storage, optical storage, and the like. The memory 206 includes computer readable instructions corresponding to an operating system (OS) (not shown), video 208, audio 210 and text 212 corresponding to the meeting. In some embodiments, the text 212 is extracted from the audio 210, for example, by the ASR engine 118. The video 208, the audio 210 and the text 212 (e.g., from ASR engine 118) is available as input, either in real-time or in a passive mode. The memory 206 further includes hyper-relevant text key phrases 214 (HRTKs), for example, obtained from the HRTK repository 122.

The memory 206 further includes a multi-modal engine (MME) 216 including a vision module 218, a tonal module 220, a text module 222, an analysis module 224 and fused data 226. Each of the modules 218, 220 and 222 extract respective characteristics from video 208, audio 210 and text 212, which characteristics are analyzed by the analysis module 224 to generate metrics of participation, for example, engagement and sentiment of the participants in the meeting. In some embodiments, the analysis module 224 combines the analyzed data from the multiple modes (vision, tonal and optionally text) to generate fused data 226, which is usable to provide one or more representative participation scores (RPS) for a participant and the meeting, and identify key moments in the meeting, for example, by identifying pronounced RPS movement for one or more participants, for one or more periods/durations of the meeting, in various combinations. In some embodiments, the analysis module 224 is also configured to generate hyper-relevant text keyphrases for industries, domains or companies, for example, from various public sources.

In some embodiments, the memory 206 further includes speech turn data 228 and episodic read module 230 or ERM 230. The speech turn data 228 includes portions of a conversation, for example, speech turns or sentences spoken by different speakers, such as the participants. The speech turns or sentences are related by a common topic. In one embodiment, the common topic is determined by a common intent or entity in each of the multiple speech turns or sentences within the episode. In some embodiments, the speech turn data 228 is generated by the ERM 230, for example, based on the an ASR text of the conversation. The ERM 230 is configured to identify, extract and analyze content from the ASR text corresponding to conversation at key moments for identifying a common topic across speech turns, for example, at or around pronounced RPS movements as identified by the analysis module 224. In some embodiments, the ERM 230 is also configured to identify hyper-relevant text keyphrases in the speech turn data 228.

FIG. 3 is a schematic representation of the user device 116 of FIG. 1, according to one or more embodiments. The user device 116 includes a CPU 302 communicatively coupled to support circuits 304 and a memory 306. The CPU 302 may be any commercially available processor, microprocessor, microcontroller, and the like. The support circuits 304 comprise well-known circuits that provide functionality to the CPU 302, such as, a user interface, clock circuits, network communications, cache, power supplies, I/O circuits, and the like. The memory 306 is any form of digital storage used for storing data and executable software. Such memory includes, but is not limited to, random access memory, read only memory, disk storage, optical storage, and the like. The memory 306 includes computer readable instructions corresponding to an operating system (OS) (not shown), and a graphical user interface (GUI) 308 to display one or more of a live or recorded meeting, and analytics with respect to participation thereon or separately. The user device 116 is usable by persons other than participants 102 while the meeting is ongoing or after the meeting is concluded. In some embodiments, the multimedia devices 104 are similar to the user device 116 in that each includes a GUI similar to the GUI 308, and each multimedia device also includes a camera, a microphone and a speaker for enabling communication between the participants during the meeting.

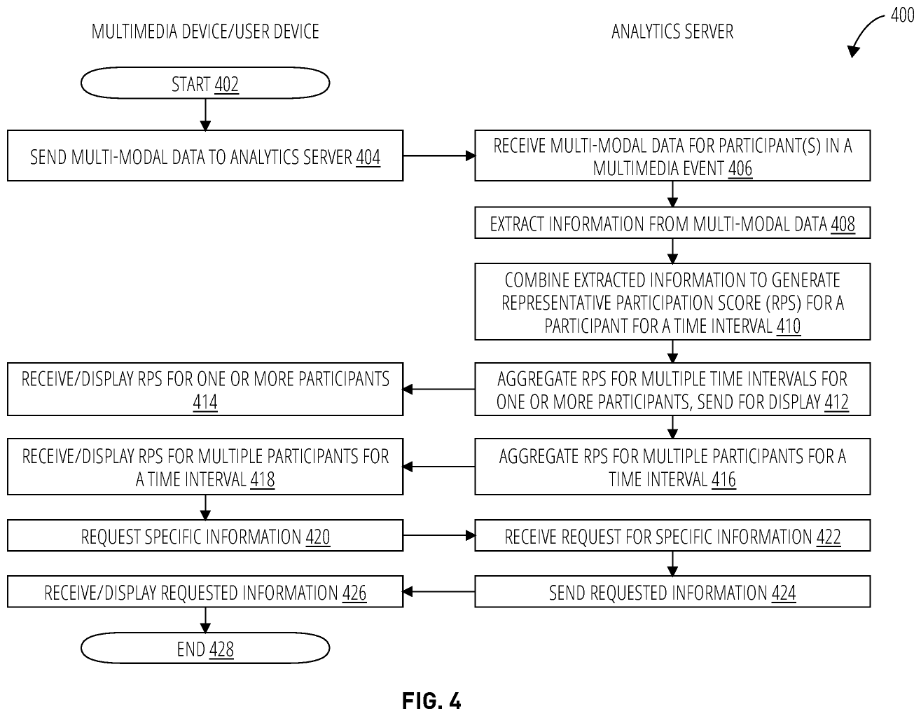

FIG. 4 illustrates a method 400 for identifying key information in a multimedia communication, for example, as performed by the apparatus 100 of FIG. 1, according to one or more embodiments. In some embodiments, steps of the method 400 performed on the analytics server 120 are performed by the MME 216. The method 400 starts at step 402, and proceeds to step 404, at which the multi-modal data (the video and audio data) of the meeting is sent from a multimedia device, for example, one or more of the multimedia devices 104 to the analytics server 120, directly or, for example, via the business server 114. In some embodiments, the multi-modal data is sent live, that is streamed, and in other embodiments, the data is sent in batches of configurable predefined time duration, such as, the entire meeting or short time bursts, for example, 5 seconds.

At step 406, the method 400 receives the multi-modal data for the participant(s) from the multimedia device(s) at the analytics server 120, and at step 408, the method 400 extracts information from each of the multi-modal data. For example, from the video 208 data, the vision module 218 extracts vision parameters for participation for each participant using facial expression analysis and gesture tracking. The parameters include facial expression based sentiments, head nods, disapprovals, among others. From the audio 210 data, the tonal module 220 extracts tonal parameters , which include tone based sentiments, self-awareness parameters such as empathy, politeness, speaking rate, talk ratio, talk over ratio, among others. From the text 212 data, obtained using the audio 210 data by the ASR engine 118, the text module 222 extracts text parameters, which include text-derived sentiments, among others. Sentiments extracted from any of the modes include one or more of happiness, surprise, anger, disgust, sadness, fear, among others.

In some embodiments, extraction of the vision, tonal and text parameters is performed using known techniques. For example, the facial expression analysis and gesture tracking is performed by the vision module 218 by tracking a fixed number of points on each face in each video frame, or a derivative thereof, for example, the position of each point in each frame averaged over a second. In some embodiments, 24 frames are captured in each second, and about 200 points on the face are tracked in each frame, the position of which may be averaged for a second to determine an average value of such points for a second. This facial expression analysis data is used as input by the vision module 218 to determine the vision parameters. In some embodiments, the vision module 218 includes one or more AI/ML models to generate an output of the vision parameters. The AI/ML model(s) of vision module 218 is/are trained using several images of faces and sentiment(s) associated therewith, using known techniques, which enables the vision module 218 to predict or determine the sentiments for an input image of the face for each participant 102. In some embodiments, the vision module 218 includes a finite computational model for determining a sentiment of a participant based on an input image of the face of each participant 102. In some embodiments, the vision module 218 includes a combination of one or more AI/ML models and/or finite computation models. The tonal module 220 analyzes the waveform input of the audio 210 to determine the tonal parameters. The tonal module 220 may include AI/ML models, computational models or both. The text module 222 analyzes the text 212 to determine text parameters, and includes sentiment analyzers as generally known in the art.

In some embodiments, each of the models 218, 220, 222 are configured to determine parameters for the same time interval on the time scale of the meeting. In some embodiments, each of the models 218, 220, 222 are configured to generate a score for corresponding parameters. In addition to determining the corresponding parameters, in some embodiments, one or more of the vision module 218, the tonal module 220 and the text module 222 generate a confidence score associated with the determined parameter to indicate a level of confidence or certainty regarding the accuracy of the determined parameter.

The method 400 proceeds to step 410, at which the method 400 combines extracted information to generate representative participation scores (RPS) for a participant for a given time interval. For example, the time interval is a second, and the method 400 generates the RPS for each second of the meeting. In some embodiments, the RPS is a combination of the scores for the vision parameters, the tonal parameters and the text parameters. In some embodiments, the scores for the vision parameters, the tonal parameters and the text parameters are normalized and then averaged to generate participation scores, that is a score for sentiment and a score for engagement, for each participant for each time interval, for example, 1 second. As used herein, participation is assessed by assessing the engagement and/or the sentiment of participants and correspondingly, the RPS include a score for engagement and a score for sentiment.

In some embodiments, the scores for the vision parameters, the tonal parameters and the text parameters are co-normed first and a weighted score is generated for engagement and for sentiment, that is the RPS. In some embodiments, an assessment is made, based on the confidence scores of each of the vision, tonal or text data, as to the certainty thereof, and the weightage of such mode is increased. In some embodiments, the mode having a confidence score below a predefined threshold, or a predefined threshold below the confidence score of other mode is ignored (weight=0). In this manner, the vision, tonal and text data for a predefined time interval of the meeting is combined or fused to generate fused data 226 for the predefined time interval, for example, a second.

At step 412, the method 400 aggregates RPS for multiple time intervals for one participant, for example, a portion of or the entire duration of the meeting. In such instances, the RPS, which includes scores for engagement and/or sentiment represents the engagement levels and/or sentiment of the participant during such time intervals. At step 416, the method 400 aggregates RPS for multiple participants over one or more time intervals, such as a portion of or the entire duration of the meeting. In such instances, the RPS represents the engagement levels and/or the sentiment of the participants for the time intervals. The number of participants, duration and starting point of time intervals is selectable, for example, using a GUI on the multimedia devices 104 or the user device 116. The aggregation may be performed by calculating a simple average over time and/or across participants, or using other statistical techniques known in the art.

One or more of the steps 406-416 discussed above may be performed after the meeting is complete, that is, in a passive mode. In some embodiments, steps 406-412 are performed in real time, that is, as soon as practically possible within the physical constraints of the elements of the apparatus 100, and in such embodiments, only the vision and tonal data is processed, and the text data is not extracted or processed to generate the RPS. Further, the RPS is generated based on a prior short time interval preceding the current moment, for example, the RPS for an instance takes into account previous 5 seconds of of vision and tonal data. In this manner, in the real-time mode, the RPS represents a current participation trend of a participant or a group of participants.

In some embodiments, the RPS for one or more participants 102 and/or a group of participants or all participants, for each second, or a portion of the meeting or the entire meeting is sent for display, for example, on the GUI 308 of the user device 116, or the GUI(s) of the multimedia devices, or any other device configured with appropriate permission and communicably coupled to the network 124. At steps 414 or 418, such devices receive and display the RPS on a GUI, for example, in the context of a recorded playback or live streaming of the meeting.

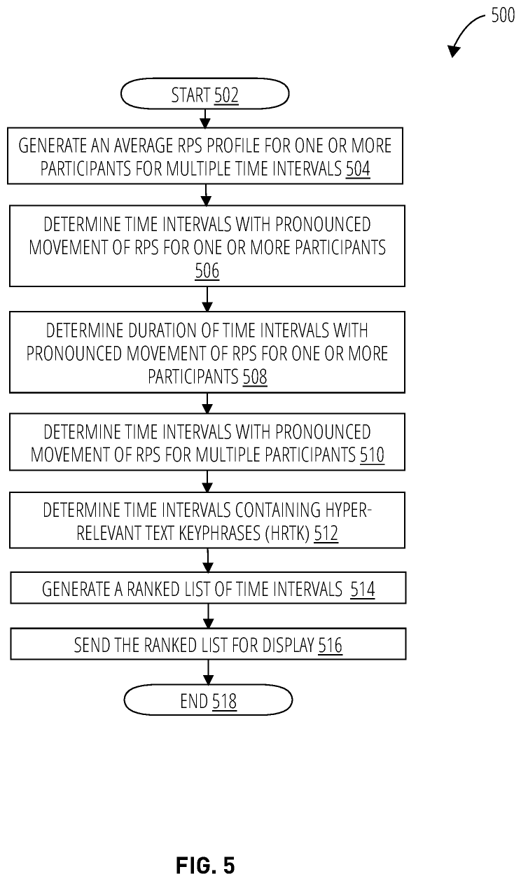

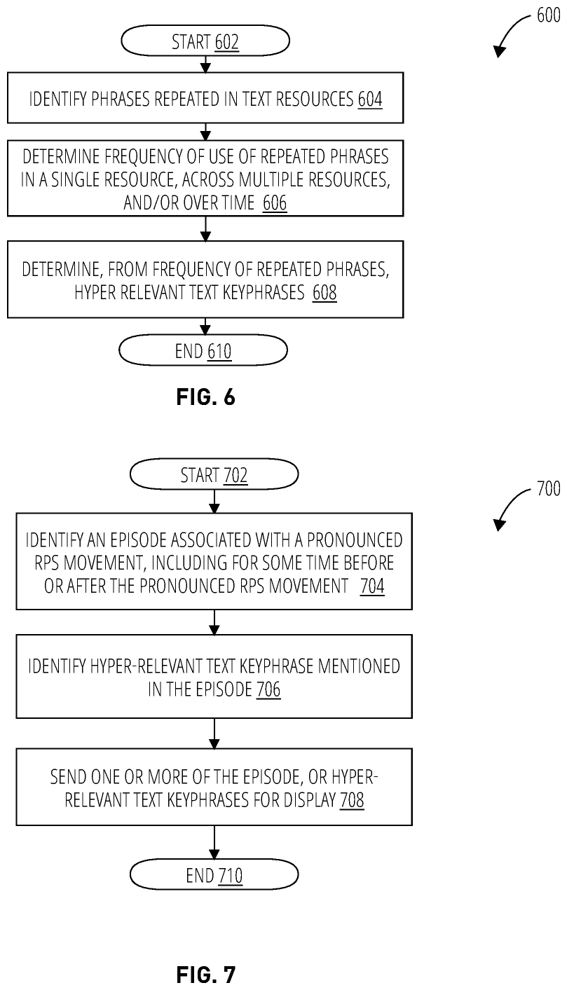

In some embodiments, at step 420, participants or other users may request specific information from the analytics server 120, for example, via the GUI in multimedia devices 104 or the GUI 308 of the user device 116. The specific information may include RPS for specific participant(s) for specific time duration(s), or any other information based on the fused data 226, RPS or constituents thereof, and information based on other techniques, for example, methods of FIG. 5 and FIG. 6. Upon receiving the request at step 422, the analytics server 120 sends the requested information to the requesting device at step 424, which receives and displays the information at step 426. The method 400 proceeds to step 428, at which the method 400 ends.

The techniques discussed herein are usable to identify a customer's participation, a business team's participation or the overall participation. Further, while a business context is used to illustrate an application of techniques discussed herein, the techniques may be applied to several other, non-business contexts.

FIG. 5 illustrates a method 500 for identifying key moments in a multi-party communication, for example, as performed by the apparatus 100 of FIG. 1, according to one or more embodiments. In some embodiments, steps of the method 500 are performed by the MME 216.

The method 500 starts at step 502 and proceeds to step 504, at which the method 500 generates an average RPS profile for one or more participants over a portion of the meeting or the entirety of the meeting, and in some embodiments, the method 500 generates an average RPS profile for each participant for the entirety of the meeting. The average RPS profile represents a baseline sentiment and/or engagement levels of a participant. For example, one participant may naturally be an excited, readily smiling person, while another may naturally have a serious and stable demeanor, and the average RPS profile accounts for the participant's natural sentiment and engagement levels throughout the meeting, and provides a baseline to draw a comparison with.

At step 506, the method 500 identifies or determines time intervals for which RPS of one or more participants has a pronounced movement, for example, time intervals in which RPS increases or decreases substantively with respect to the average RPS profile for a given participant. A pronounced movement with respect to the average RPS profile indicates a significant change in the sentiment and/or engagement of the participant, and a potentially important time interval(s) in the meeting for that participant. The pronounced movement could be defined as movement in the RPS (difference between the RPS for a moment and the average RPS for a participant) greater than a predefined threshold value.

Steps 504 and 506 help identify important moments for participants based on the participant averaged engagement throughout the meeting. In some embodiments however, the step 504 is not performed, and step 506 determines pronounced movement by comparing a movement of the RPS over time, greater than a predefined threshold. That is, if the RPS of a participant increases (or decreases) more than a predefined threshold value compared to a current RPS within a predefined time interval, for example, 10 seconds, then such time intervals are identified as potentially important time interval(s) for that participant. The time intervals determined at step 506, whether using the averaged RPS score according to step 504 or using absolute movement in the RPS score without using the step 504, are referred to as ‘swings’ in the participation.

At step 508, the method 500 determines the time intervals for which the pronounced movement of the RPS is sustained for one or more participants, for example, for a time duration greater than a predefined threshold. Such time intervals are referred to as ‘profound’ swings.

At step 510, the method 500 determines the time intervals with swings and/or profound swings for multiple participants that overlap or occur at the same time, that is, time intervals in which more than one participant had a pronounced RPS movement, or pronounced RPS movement for a sustained duration of time. Multiple participants having swings and/or pronounced swings in the same or proximate time intervals indicate a mirroring of participation of one or some participant(s) by one or other participant(s). Such time intervals are referred to as ‘mirrored’ swings. Mirrored swings include swings in the RPS of one participant in the same or opposite direction, that is other participants may exhibit similar reaction or opposite reactions to the one participant.

At step 512, the method 500 determines, from time intervals identified at steps 506 (swings), 508 (pronounced swings) and/or step 510 (mirrored swings), the time intervals that contain one or more instances of phrases from a list of predefined phrases that are considered relevant to an industry, domain, company/business or any other parameter. Such phrases are referred to as hyper-relevant text keyphrases (HRTKs) and the time intervals are referred to as blended key moments.

Any of the time intervals identified at steps 506 (swings), 508 (pronounced swings), 510 (mirrored swings) or 512 (blended key moments) are identified as important moments of the meeting, or moments that matter, and at step 514, one or a combination of the swings, pronounced swings, mirrored swings or blended key moments are ranked. In some embodiments, only one type of swings, for example, the pronounced swings, or the mirrored swings or the pronounced and mirrored swings are ranked. Ranking is done according to the quantum of swing, that is, according to the movement of the RPS for the time intervals, cumulated for all or some participants. In some embodiments, the cumulation is performed by summation, averaging, or another statistical model, to arrive at the quantum of movement (or the swing) of the RPS. The time intervals or moments are ranked high if the quantum of the movement of the RPS is high, and lower if the quantum of the movement of the RPS is lower.

At step 516, the method 500 sends the ranked list to a device for display thereon, for example, a device remote to the analytics server 120, such as the multimedia devices or the user device 116. In some instances, the ranked list is sent upon a request received from such a device. The ranked list identifies the portions of the meeting that are considered important. The method 500 proceeds to step 518, at which the method 500 ends.

While the method 500 discusses techniques to identify moments that matter in a single meeting, in some embodiments, blended key moments are identified in moments across different meetings involving the same participants, business or organization, or any other common entity, for example, a customer company treated as an “account” by a provider company selling to the customer company, and a “deal” with the “account” takes several meetings over several months to complete the deal. Blended key moments identified in different meetings held over time are used to identify HRTKs that persistently draw a pronounced or swing reaction from participants. For example, such blended key moments across different meetings are used to identify terms that induced negative, neutral or positive reactions, and based on identification of such terms, propositions that are valuable, factors that were considered negative or low impact, among several other inferences are drawn.

FIG. 6 illustrates a method 600 for generating hyper-relevant text keyphrases, according to one or more embodiments. In some embodiments, the method 600 is performed by the analysis module 224 of FIG. 1, however, in other embodiments, other devices or modules may be utilized to generate the HRTKs, including sourcing HRTKs from third party sources.

The method 600 starts at step 602, and proceeds to step 604, at which the method 600 identifies phrases repeated in one or more text resources, for example, websites, discussion forums, blogs, transcripts of conversations (voice or chat) or other sources of pertinent text. At step 606, the method 600 identifies, the frequency of occurrence of such phrases repeated in a single resource, across multiple resources and/or resources made available over time. In step 608, determine, from the frequency of repeated phrases, hyper relevant keyphrases. The method 600 proceeds to step 610, at which the method ends.

In some embodiments, step 604 is performed ongoingly on existing and new text resources to update hyper-relevant text keyphrases (HRTKs) dynamically. In some embodiments, the HRTK repository 122 is updated dynamically after performing step 604, for example, by the analysis modules 224. In some examples, HRTK repository 122 is updated by a third party service, or similar other services.

FIG. 7 illustrates a method 700 for identifying an episode in a multimedia communication, according to one or more embodiments. In some embodiments, the method 700 is performed by the ERM 230 of FIG. 2. The method 700 starts at step 702, and proceeds to step 704.

At step 704, the method 700 identifies an episode at a time duration associated with a pronounced movement of the RPS. For example, if a time duration between times t1 and t2 is known to have a pronounced movement of the RPS, the ERM 230 analyzes the conversation between t1 and t2 to identify the transcribed text of the conversation (e.g., from the text 212) between one or more participants. In some embodiments, the ERM 230 analyzes conversation between a time or speaker turns before t1 and/or a time or speaker turns after t2, or any combination thereof. The conversation is analyzed for a common topic. In some embodiments, each speech turn of the conversation is analyzed for a common entity and/or a common intent. In some embodiments, each speech turn of the conversation is analyzed for common words. If two or more speech turns include a common entity, a common intent, or a common word (stop words, commonly used conversational words may be excluded), such speech turns are considered to relate to a common topic. In some embodiments, the ERM 230 analyzes conversation starting from the duration of the pronounced RPS movement to identify a first speech turn, and analyzes the conversation from durations before the pronounced RPS movement and/or after the pronounced RPS movement, till a second speech turn common to the topic of the first speech turn is found. The episode is defined to encompass the conversation including the first speech turn and the second speech turn, and all the other speech turns in between, and the episode is associated with the pronounced RPS movement.

In some embodiments, at step 706, the method 700 analyzes the episode to identify hyper-relevant text keyphrases (HRTKs) therein. If any HRTKs identified within the episode, such HRTKs are considered relevant to the pronounced RPS movement.

The method 700 proceeds to step 708, at which the method 700 sends one or more of the episode conversation, or HRTKs identified within the episode for display, for example, at the user device 116, the one or more multimedia devices, or to a publication service configured for displaying the key information.

The method 700 proceeds to step 710, at which the method 700 ends.

Several recorded meetings are available over time, and various techniques described herein are further supplemented by cumulated tracking data for each of the participants, organization(s) thereof, a topic (e.g., a deal) of a meeting, keywords, among other unifying themes, in a meeting or across different meetings. Several other graphic representations using the RPS scores and assessment/analysis of participation (sentiment and engagement) performed in real time and/or after conclusion of the meeting are contemplated herein, such as overlaying the RPS scores and/or analysis over a recording or a live streaming playback of the meeting, for moments that matter for a participant, or multiple participants, and for presenting hyper-relevant text key phrases associated with specific sentiments in a meeting or across different meetings. Further, in some embodiments including real time computations, time delays may be introduced in the computation, for example, to perform computation on aggregated data, to present aggregated information, among other factors.

Although various methods discussed herein depict a particular sequence of operations, the sequence may be altered without departing from the scope of the present disclosure, unless otherwise apparent from the context. For example, some of the operations depicted may be performed in parallel or in a different sequence that does not materially affect the function of the methods discussed herein. In other examples, different components of an example device or apparatus that implements the methods may perform functions at substantially the same time or in a specific sequence.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

While the foregoing is directed to embodiments of the present invention, other and further embodiments of the invention may be devised without departing from the basic scope thereof.

I/We claim:

1. A computer implemented method for identifying an episode in a multi-party multimedia communication, the method comprising:
receiving, at an analytics server, from a plurality of multimedia devices in a multimedia communication between a plurality of participants, multi-modal data comprising video data and audio data for at least one of the plurality of participants, wherein the plurality of multimedia devices are remote to the analytics server;
extracting, for each of the plurality of participants, vision information from the video data, at least one of tonal information or text information from the audio data;
determining a representative participation score (RPS) based on the vision information and the at least one of the tonal information or the text information, for each of the plurality of participants, for a plurality of consecutive time intervals;
determining a pronounced RPS movement
for at least one of the plurality of participants during a first plurality of time intervals,
for at least two of the plurality of participants during a second plurality of time intervals, or
for at least a predefined duration for at least one of the plurality of participants during a third plurality of time intervals;
identifying an episode associated with the pronounced RPS movement, the episode defined by at least two speech turns related to a topic; and
sending the episode for display.

2. The method of claim 1, wherein each of the at least two speech turns comprise at least one of a common entity or a common intent.

3. The method of claim 2, wherein the identifying the episode comprises:
analyzing conversation between the plurality of participants during the pronounced RPS movement; and
analyzing conversation between the plurality of participants in at least one of
a duration or a number of speaker turns before the pronounced RPS movement, or
a duration or a number of speaker turns after the pronounced RPS movement.

4. The method of claim 3, wherein the duration of the episode is different from the duration of the pronounced RPS movement.

5. The method of claim 3, further comprising:
identifying a hyper-relevant text keyphrase mentioned during the episode; and
sending the identified hyper-relevant text keyphrase for display.

6. A computing apparatus comprising:
a processor; and
a memory storing instructions that, when executed by the processor, configure the apparatus to:
receive, at an analytics server, from a plurality of multimedia devices in a multimedia communication between a plurality of participants, multi-modal data comprising video data and audio data for at least one of the plurality of participants, wherein the plurality of multimedia devices are remote to the analytics server;
extract, for each of the plurality of participants, vision information from the video data, at least one of tonal information or text information from the audio data;
determine a representative participation score (RPS) based on the vision information and the at least one of the tonal information or the text information, for each of the plurality of participants, for a plurality of consecutive time intervals;
determine a pronounced RPS movement
for at least one of the plurality of participants during a first plurality of time intervals,
for at least two of the plurality of participants during a second plurality of time intervals, or
for at least a predefined duration for at least one of the plurality of participants during a third plurality of time intervals;
identify an episode corresponding to the pronounced RPS movement, the episode defined by at least two speech turns related to a topic; and
send the episode for display.

7. The computing apparatus of claim 6, wherein each of the at least two speech turns comprise at least one of a common entity or a common intent.

8. The computing apparatus of claim 7, wherein the identifying the episode comprises:
analyze conversation between the plurality of participants during the pronounced RPS movement; and
analyze conversation between the plurality of participants in at least one of
a duration or a number of speaker turns before the pronounced RPS movement, or
a duration or a number of speaker turns after the pronounced RPS movement.

9. The computing apparatus of claim 8, wherein the duration of the episode is different from the duration of the pronounced RPS movement.

10. The computing apparatus of claim 8, wherein the instructions further configure the apparatus to:
identify a hyper-relevant text keyphrase mentioned during the episode; and
send the identified hyper-relevant text keyphrase for display.

11. A non-transitory computer-readable storage medium, the computer-readable storage medium including instructions that when executed by a computer, cause the computer to:
receive, at an analytics server, from a plurality of multimedia devices in a multimedia communication between a plurality of participants, multi-modal data comprising video data and audio data for at least one of the plurality of participants, wherein the plurality of multimedia devices are remote to the analytics server;
extract, for each of the plurality of participants, vision information from the video data, at least one of tonal information or text information from the audio data;
determine a representative participation score (RPS) based on the vision information and the at least one of the tonal information or the text information, for each of the plurality of participants, for a plurality of consecutive time intervals;
determine a pronounced RPS movement
for at least one of the plurality of participants during a first plurality of time intervals,
for at least two of the plurality of participants during a second plurality of time intervals, or
for at least a predefined duration for at least one of the plurality of participants during a third plurality of time intervals;
identify an episode corresponding to the pronounced RPS movement, the episode defined by at least two speech turns related to a topic; and
send the episode for display.

12. The computer-readable storage medium of claim 11, wherein each of the at least two speech turns comprise at least one of a common entity or a common intent.

13. The computer-readable storage medium of claim 12, wherein the identifying the episode comprises:
analyze conversation between the plurality of participants during the pronounced RPS movement; and
analyze conversation between the plurality of participants in at least one of
a duration or a number of speaker turns before the pronounced RPS movement, or
a duration or a number of speaker turns after the pronounced RPS movement.

14. The computer-readable storage medium of claim 13, wherein the duration of the episode is different from the duration of the pronounced RPS movement.

15. The computer-readable storage medium of claim 13, wherein the instructions further configure the computer to:
identify a hyper-relevant text keyphrase mentioned during the episode; and
send the identified hyper-relevant text keyphrase for display.
